(19) United States
(12) Patent Application Publication
(10) Pub. No.: US 2025/0327354 A1
(43) Pub. Date: Oct. 23, 2025

(54) SYSTEM AND METHOD FOR OPERATING A FRONT TRUNK OF AN ELECTRIC VEHICLE BASED ON LOAD

(71) Applicant: FCA US LLC, Auburn Hills, MI (US)

(72) Inventors: Patrick D Reed, Washington, MI (US); Jason L Vincent, Howell, MI (US); Richard S Silbert, Bingham Farms, MI (US)

(21) Appl. No.: 18/640,077

(22) Filed: Apr. 19, 2024

(51) Int. Cl. E05F 15/75; B60R 5/02; B62D 25/20; E05F 15/611; G01G 19/08; G01G 23/18

(52) U.S. Cl. CPC E05F 15/75; B60R 5/02; B62D 25/20; E05F 15/611; G01G 19/08; G01G 23/18; E05Y 2400/55; E05Y 2900/548

(57) ABSTRACT

A front trunk system for an automotive vehicle a front trunk system for an automotive vehicle having a front trunk door and a frunk load floor includes a load sensor coupled to the frunk load floor that generates a load signal corresponding to a load on the load floor. The system further includes a controller coupled to the load sensor controlling an indicator when the load is greater than a load threshold.

### FIELD

The present disclosure relates to a front truck, and more specifically to a method and system for operating the front trunk.

### BACKGROUND

This section provides background information related to the present disclosure which is not necessarily prior art.

Electrified vehicles have batteries that are located in various locations throughout the vehicle. The location of the battery is not in the front of the vehicle like a typical internal combustion engine. Therefore, space in front of the passenger compartment is available for storage. The storage area in front of the vehicle is referred to as a front trunk (frunk) or front cargo area. The frunk is a highly desired customer feature.

A frunk typically has more limited cargo space than a traditional trunk. A front door typically encloses the frunk and may also be referred to as a hood. Because of the limited cargo space, there are risks associated with overfilling of the frunk. The objects being stored within the frunk may be damaged. Likewise, the load floor of the frunk may be damaged when overloaded.

### SUMMARY

This section provides a general summary of the disclosure and is not a comprehensive disclosure of its full scope or all of its features.

The present disclosure generates an alert through an indicator to the vehicle operator to prevent damage to the vehicle or objects inside when weight overloaded.

In one aspect of the disclosure, a front trunk system for an automotive vehicle having a front trunk door and a frunk load floor includes a load sensor coupled to the frunk load floor that generates a load signal corresponding to a load on the load floor. The system further includes a controller coupled to the load sensor controlling an indicator when the load is greater than a load threshold.

In another aspect of the disclosure, a method of controlling a front trunk system for an automotive vehicle having a front trunk door and frunk load floor includes generating a load signal corresponding to a load on the frunk load floor and controlling an indicator when the load is greater than a load threshold.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1A is a diagrammatic view of a motor vehicle having a front trunk.

FIG. 1B is one example of a user interface illustrated in FIG. 1A.

FIG. 1C is a cross section of a load cell relative to the load floor.

FIG. 1D is a front trunk door in a partial opened and a closed position.

FIG. 2 is a block diagrammatic view of the system.

FIG. 3 is a flowchart of a method for operating the system.

Corresponding reference numerals indicate corresponding parts throughout the several views of the drawings.

### DETAILED DESCRIPTION

Example embodiments will now be described more fully with reference to the accompanying drawings.

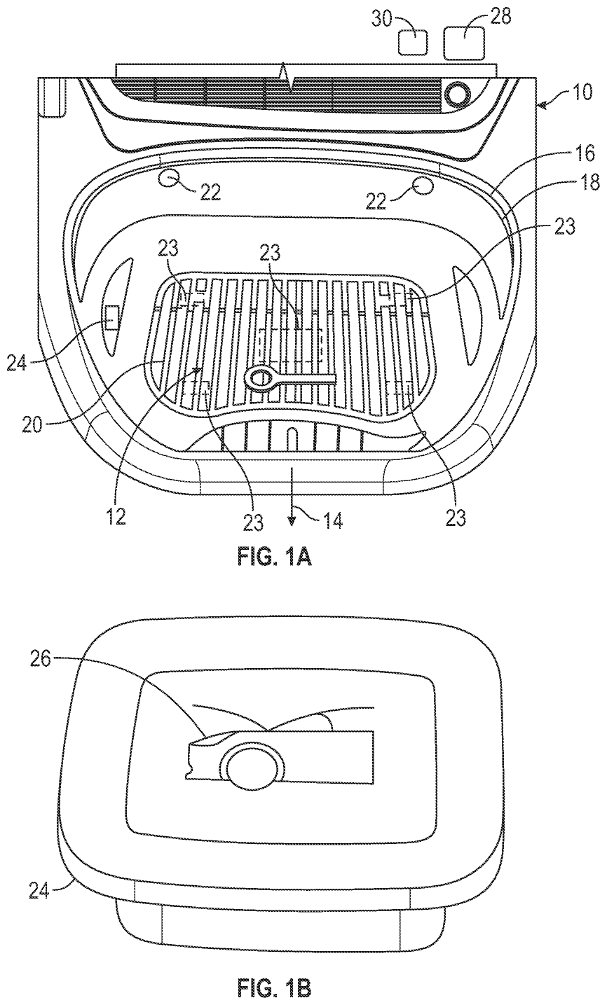

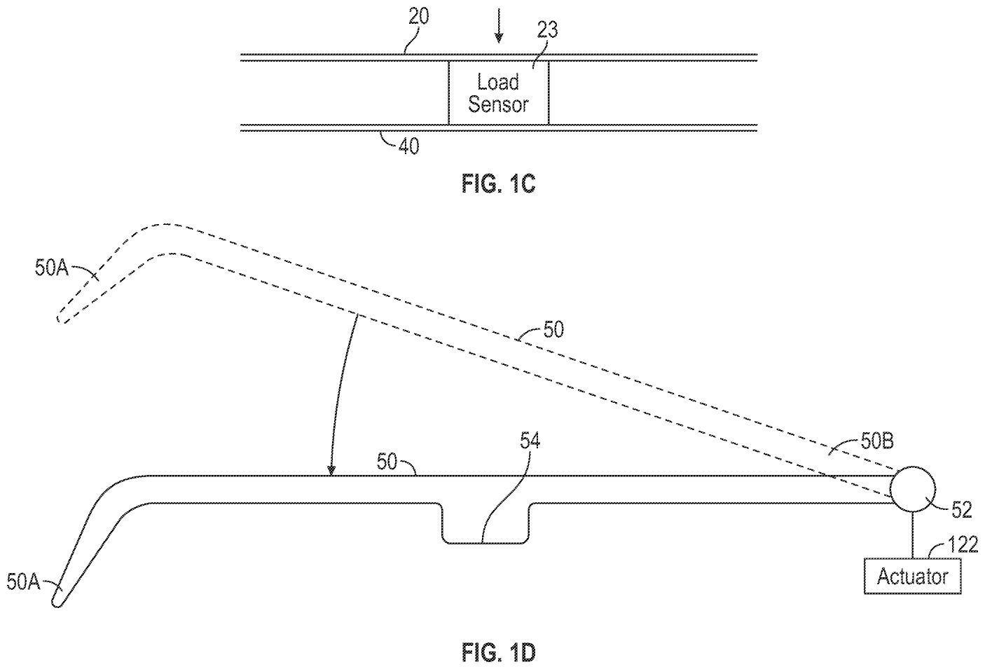

Referring now to FIG. 1A, an automotive vehicle 10 having a front trunk 12 is illustrated. The front trunk 12 is illustrated without a front door or hood so that the interior of the front trunk 12 is illustrated. In this example, the front trunk 12 has a length in the direction of the longitudinal axis 14. The front trunk 12 has a lateral width and depth to hold cargo. Typically, the frunk 12 is molded from plastic or another finish. The surfaces of the molded frunk may be carpeted or composite material. Frunks for different vehicles will have different shapes depending upon the package size and the vehicle design.

The front trunk 12 has an opening 16 that may be sealed by a rubber seal 18 to prevent water from intruding. The front trunk 12 has a load floor 20 that is used for supporting the objects within the front trunk 12. The frunk 12 and the load floor 20 therein is made to support a certain amount of weight.

Lights 22 may be disposed at various locations within the front trunk 12 so that when the front trunk door is opened, the lights 22 are illuminated to illuminate the objects within the front trunk 12. In this example, two lights 22 are illustrated. However, one light or more than two lights 22 are used in different examples. The lights 22 may also be referred to as a visual indicator to indicate the load on the load floor 20 as indicated by the load cell 23 is over a load floor threshold will be described in more detail below. The lights 22 may be incandescent lights or another type of light source such as a light emitting diode or plurality of diodes.

Referring now also to FIG. 1B, one example of a user interface 24 is set forth. The user interface 24, in this example, has an image 26 that is indicative of a control for the front trunk 12. The user interface 24, as illustrated in FIG. 1A, is located in the interior of the frunk 12. The user interface 24 may also be illuminated or back lit and may be used as an emergency latch for someone trapped within the front trunk 12. That is, the user interface 24 can act as a release to unlatch the front trunk 12.

A user interface 28, in this example, is disposed within the vehicle 10. The user interface 28 may be a separate push button or an electronic button displayed on a touch screen display such as a center console screen display.

An indicator 30 disposed within the passenger compartment is used in this example. The indicator 30 illuminates when the load sensor 23 indicates the load on the load floor 20 is over a load threshold. The indicator 30 and the lights 22, as well as the interface 24, may illuminate when the load is over the load threshold. A positive illumination may also be used. For example, the user interface 24, the indicator 30 and the lights 22 may be white or green lights when the load on the load floor is below a load threshold and red when the load on the load floor 20 is greater than a load threshold.

In FIG. 1C, the load sensor 23 is illustrated in further detail. The load sensor 23 is disposed between the load floor 20 and some vehicle structure 40 such as a sub-floor, a frame, a stamped panel, or the like. The load sensor 23 may be referred to as a load cell or load cell amplifier. Although one load sensor 23 is illustrated more than one load sensor 23 may be implemented. For example, load sensors 23 may be distributed near each corner of the load floor 20 as shown in FIG. 1A in addition to or instead of the centrally located load sensor 23.

As illustrated in FIG. 1D, a front trunk door 50 is illustrated. In this example, the front trunk door 50 has a front end 50A and a rearmost end 50B. A hinge 52 allows the front trunk door 50 to move between an open and a closed position. The front trunk door 50 may have various support portions 54 extending therefrom for structural support. In this example, one support portion 54 is illustrated. However, several support portions may be provided on a front trunk door 50. The support portion 54 may extend downward into the front trunk 12. The trunk door 50 is shown in solid lines in a closed position and dashed lines in an opened position. An actuator 122 may be used to move the door 50 between the open and closed position.

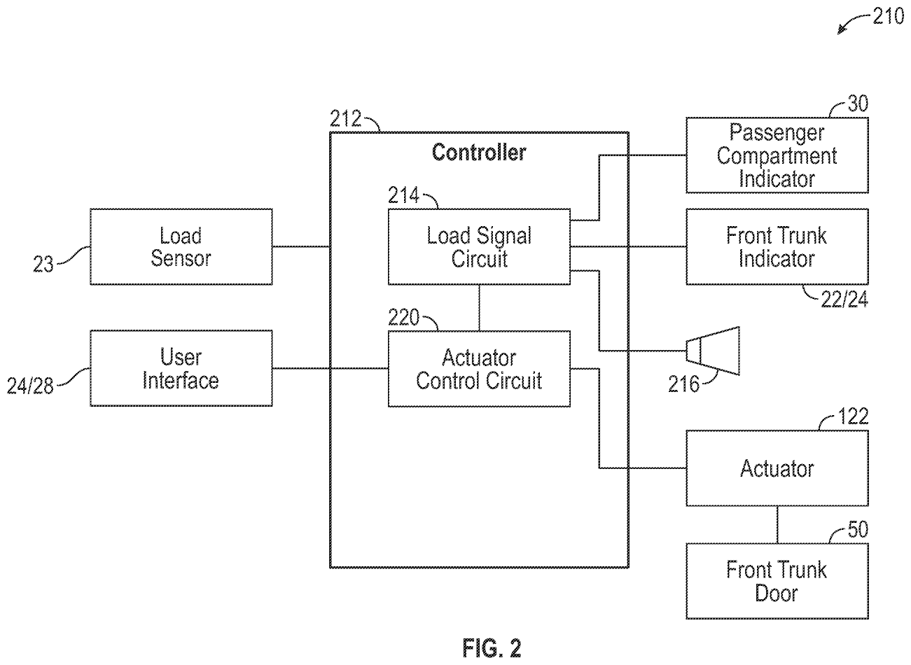

Referring now to FIG. 2, a block diagrammatic view of a front trunk system 210 having a controller 212 is set forth. The controller 212 may be formed of a microprocessor or discrete circuitry used for controlling the various functions. Load signal circuit 214 is disposed within the controller 212. The load signal circuit 214 may control the passenger compartment indicator 30, the lights 22 and/or the user interface 24. Likewise, a speaker 216 or other acoustic generating device may be used to generate an audible indicator. As mentioned above, the load signal circuit 214 may generate or control the indicators 22 and 30 to indicate a load floor load over a load threshold. Therefore, the load signal circuit 214 acts as a comparator in comparing a load threshold and a load from the one or more load sensors 23. For example, a red indicator light may be used. The load signal circuit 214 may also generate an indicator when load is below a weight threshold, such as a white light. The change between the white light and the red light is used to indicate an overload condition.

The controller 212 may include an actuator control circuit 220 in communication with the load signal circuit 214. The actuator control circuit 220 is used to control an actuator 122 for an automatic front trunk closing system. That is, the actuator 122 and the door 50 associated therewith may close off the front trunk 12 by moving the front trunk door 50 associated therewith. One example of an actuator 122 is a motor. The user interface 24/28 is used to provide an input signal to the actuator control circuit 220 when the front trunk door 50 is desired to be closed. The user interface 24/28 may also be used to open the front trunk door 50 by controlling the actuator 122. Controlling the actuator may be based on signals from the load signal circuit 214.

The audible indicator or speaker 216 may also include the user of the vehicle horn or a fratzonic resonance chamber.

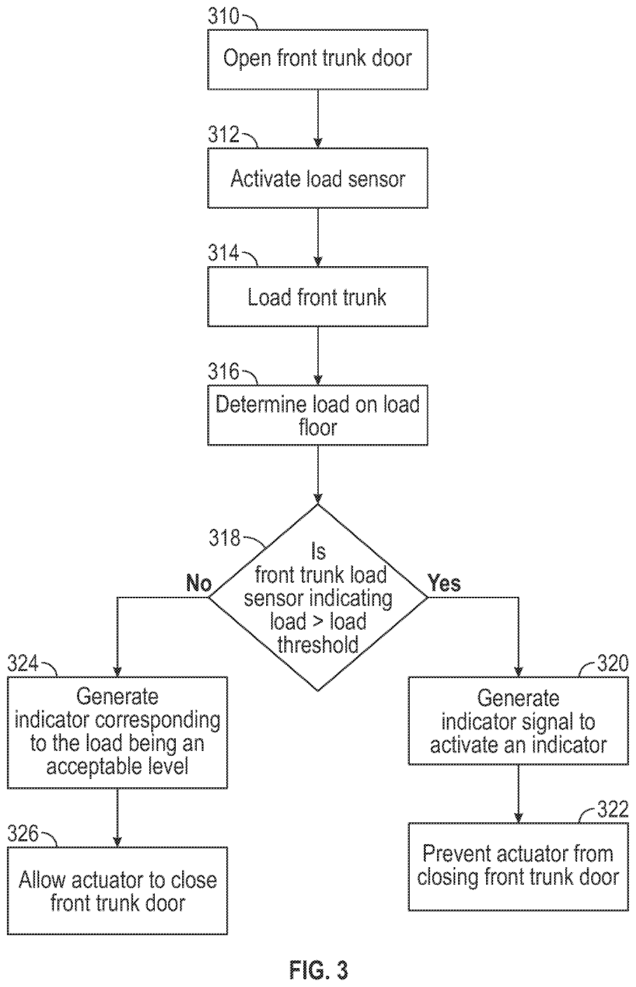

Referring now to FIG. 3, a flowchart of a method for controlling the system 210 of FIG. 2 is set forth. In step 310, the door 50 of the front truck 12 is opened. A manual latch may be provided. However, a remote control device or another type of user interface, such as the user interface 24, may be used to open the front trunk door 50. In step 312, the load sensor 42 is activated to measure the load. However, the load sensor 42 may be continually activated. By activating the load sensor, a load signal corresponding to the load on the load floor is communicated to the controller 212.

In step 314, the front trunk is loaded. The front trunk loaded preferably to a load or weight less than a load threshold. The load on the load floor is determined in step 316.

In step 318, the front trunk load sensor compares the front trunk load and a load threshold. When the load indicated by the load sensor signal is above the load threshold, an indicator signal is generated to activate an indicator in step 320. As mentioned above, the indicator may be a visual indicator and change the color of one of the indicators or generate an audible indicator in step 320. Step 322 may prevent the actuator from closing the front trunk door.

Referring back to step 318, when the front trunk load sensor does not indicate the load is over the load threshold, an indicator corresponding to a below threshold load may be optionally generated in step 324. That is, white lights or a normal closing sound without a warning sound may be generated to indicate the load on the load floor is at an acceptable level. In step 326, the front truck door is allowed to be closed by the actuators. Steps 322 and 324 are optional steps corresponding to when a front trunk actuator is present. The front trunk monitoring process may continually be performed after the front trunk is opened or before closing the front trunk door.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A front trunk system for an automotive vehicle having a front trunk door and a frunk load floor comprising:
a load sensor coupled to the frunk load floor generating a load signal corresponding to a load on the load floor; and
a controller coupled to the load sensor controlling an indicator when the load is greater than a load threshold.

2. The front trunk system of claim 1 wherein the load sensor comprises a load cell amplifier.

3. The front trunk system of claim 1 wherein the load sensor is disposed between the load floor and a vehicle structure.

4. The front trunk system of claim 3 wherein the vehicle structure comprises a sub-floor.

5. The front trunk system of claim 2 wherein the load sensor comprises a plurality of load sensors.

6. The front trunk system of claim 1 wherein the indicator comprises a visual indicator or an audible indicator.

7. The front trunk system of claim 1 wherein the indicator comprises a visual indicator and an audible indicator.

8. The front trunk system of claim 7 wherein the visual indicator is disposed within the front trunk.

9. The front trunk system of claim 1 further comprising a user interface and an actuator for closing the front trunk door, said controller preventing the actuator from closing the front trunk door based on the load signal.

10. The front trunk system of claim 9 wherein the actuator comprises a motor.

11. A method of controlling a front trunk system for an automotive vehicle having a front trunk door and frunk load floor, said method comprising:
generating a load signal corresponding to a load on the frunk load floor; and
controlling an indicator when the load is greater than a load threshold.

12. The method of claim 11 wherein generating the load signal comprises generating the load signal from a load sensor.

13. The method of claim 11 wherein generating the load signal comprises generating the load signal from a load cell.

14. The method of claim 11 wherein generating the load signal comprises generating the load signal from a load cell amplifier.

15. The method of claim 11 wherein generating the load signal comprises generating the load signal from a plurality of load sensors.

16. The method of claim 11 wherein generating the load signal comprises generating the load signal from a load sensor disposed between a load floor and a vehicle structure.

17. The method of claim 11 wherein controlling the indicator comprises controlling a visual indicator.

18. The method of claim 11 wherein controlling the indicator comprises controlling a visual indicator disposed within the front trunk.

19. The method of claim 11 wherein the indicator comprises an audible indicator, a visual indicator or both.

20. The method of claim 11 further comprising preventing an actuator from closing the front trunk door after generating an actuator signal based on the load signal.
